(19) United States
(12) Patent Application Publication
(10) Pub. No.: US 2006/0074810 A1
(43) Pub. Date: Apr. 6, 2006

(54) Method of considering content equivalency when rendering content

(76) Inventors: Mark Henricus Verberkt, Eindhoven (NL); Koen Hendrik Jhan Vrielink, Eindhoven (NL); David Peter Louis Simons, Eindhoven (NL); Markus (nmi) Baumeister, Aachen (DK)

Correspondence Address: PHILIPS INTELLECTUAL PROPERTY & STANDARDS, P.O. BOX 3001, BRIARCLIFF MANOR, NY, 10510, US

(21) Appl. No.: 10/537,456

(22) PCT Filed: Nov. 28, 2003
(86) PCT No.: PCT/IB03/05548

§ 371 Date: Jun. 3, 2005

Related U.S. Application Data
(63) Continuation-in-part of application No. 60/430,966, filed on Dec. 4, 2002.

(51) Int. Cl. G06Q 99/00

(52) U.S. Cl. 705/57

(57) ABSTRACT

A method of controlling content rendering to one or more content rendering devices (22, 24, 26, 28) associated with a consumer environment (12) includes receiving an initial content reference from within the consumer environment. Zero or more equivalent content references associated with the initial content reference are identified. A preferred equivalent content reference associated with the consumer environment is selected from the initial content reference and the equivalent content references. A content instance described by the preferred equivalent content reference is rendered on a first content rendering device. The method may also include selecting a preferred content rendering device associated with the consumer environment. The preferred content rendering device is compatible with the preferred equivalent content reference. A content instance described by the preferred equivalent content reference is then rendered to the preferred content rendering device. In another embodiment, a consumer environment (12) includes: a consumer network (14), a receiver (18), a content equivalency server (20), one or more content rendering devices (22, 24, 26, 28), and a controller (16).

The invention relates to an apparatus and method for considering content equivalencies when rendering content to a content rendering device. It finds particular application in conjunction with selection of a content source and selection of audio/video content rendering devices based on certain preferences and will be described with particular reference thereto. However, it is to be appreciated that the invention is also amenable to other applications.

Numerous advances have been made in consumer electronics (CE) devices, such as receiving, recording and content rendering devices for audio, video, and multimedia content. At the same time, communication technologies have also been advancing at a rapid rate. For example, digital streaming technology has provided users with the ability to obtain audio, video, and multimedia content via computer networks, such as the Internet. Significant advances are also occurring in other communication technology areas such as, e.g., home networking and automation, Internet access, and mobile wireless data services and devices.

Home environments contain a large variety of digital devices. For example, a home environment may include digital televisions (TVs), mobile phones, personal digital assistants (PDAs), satellite receivers, cable TV receivers, terrestrial antennas, DVD players, digital video recorders, etc. Furthermore, these devices may be interconnected in a “home network” by one or more home networking technologies.

The expression “home network” generally refers to a collection of interconnected apparatus in and around the home. An apparatus on the network can communicate with one or more of the other apparatus so as to provide distributed functionalities and synergy through interoperability, typically under control of software applications and macros. The network provides functionalities such as entertainment and education (e.g., audio and video play-out, electronic program guides (EPGs)), control (e.g., thermostat, lights, sprinkler, kitchen appliances) and monitoring (e.g., security system, baby monitor). A variety of software architectures may be implemented in a home network. Examples thereof include HAVi, Home API, UPnP, Jini, HomeRF, HomePNA, etc.

Several examples of a home network are discussed in PCT Published Patent Application WO 02/13463 A3. Devices within a locale, such as a home, are controlled by detecting the presence of an identified user within different areas of the locale. The devices within the areas are controlled in response to each identified user's preferences. The locating and control devices may be stand-alone devices, or integrated within other electronic devices, such as TVs, stereos, computers, and so on. Also provided in this example of a home network are user task modules that suggest control actions based on the location of the user, the current context, and a profile of the user based upon the user's prior actions. The determination of each user's location is facilitated by the use of a tracker module that the user carries about. The user may determine the degree of automation to be applied at any time.

Another example of a home network discussed in WO 02/13463 A3 relates to a data management system that combines the data of an EPG with other data for other types of content information, typically within the context of a home entertainment system. The system comprises a database for representing schedule information associated with scheduled content information from a content provider such as a broadcasting station or a video-on-demand (VOD) service. In addition, the database also represents inventory information that is associated with content information available from another resource, e.g., as recorded at the consumer's digital Personal TV Receiver during previous broadcasts, or from a CD or DVD jukebox.

Yet another example of a home network discussed in WO 02/13463 A3 includes a server system that maintains a user profile of a particular end-user of CE network-enabled equipment and a database of technical features for this type of equipment. If there is a match between the user-profile and a technical feature, and the user indicates to receive information about updates or sales offers, the user gets notified via the network of the option to obtain information about the feature.

Still another home network example in WO 02/13463 A3 relates to a server that has access to an inventory of devices and capabilities on a user's home network. The inventory is, for example, a look-up service as provided by HAVi or Jini architecture. The server also has access to a database with information of features for a network. The server determines if the synergy of the apparatus present on the user's network can be enhanced based on the listing of the inventory and on the user's profile. If there are features that are relevant to the synergy, based on these criteria, the user is notified.

The rendering capabilities of different CE devices often differs. For instance, a digital TV may be capable of decoding high-resolution content streams, e.g., DVB MPEG-2 streams, while mobile phones may only be able to decode low-resolution content streams, e.g., MPEG-4 movies transmitted via UMTS.

In addition to heterogeneity in content rendering capabilities, the home networking capabilities of CE devices may also differ. For example, a TV may be equipped with a high bit rate IEEE 1394 interface, a PDA may be equipped with a moderate bit rate IEEE 802.11b wireless interface, and a mobile phone may be equipped with a low bit rate Bluetooth interface.

In this heterogeneous environment, a user should be able to access as much of the content available to the home on as many CE devices as possible. The content available from various service provider networks may include cable TV, satellite TV, wire and wireless telephone, and radio and TV broadcast. Content may also be available from some various storage devices in the home (e.g., DVD players, video and audio recorders, CD players, etc.). The same content is often available in different formats or via different service provider networks.

Furthermore, the fact that CE devices in the home are interconnected enables a content provider to provide services to various devices, thus increasing the viewing time of the content provider's content. One way in which this can be achieved is by offering content in different formats. The various formats may be transported via different networks. This enables the same content to be rendered on different CE devices even though each device requires a particular format, a particular network interface, or both. Several examples of different formats over different networks include radio, TV, and the Internet. A content provider could, for example, broadcast a specific sports event via DVB-MPEG2, via UMTS-MPEG4, and via radio (e.g., FM/DAB). This enables a consumer to follow the event using his home cinema, mobile phone, or portable radio.

Multiple streams or files of data that, from a consumer's point of view, are related or very similar are referred to as—“equivalent content”— even though the streams or data are technically very different. Different types of content equivalencies may be distinguished as follows: 1) content that is exactly the same with different encoding characteristics (e.g., encoding scheme, bandwidth etc.); 2) content that is the same, but, for example, the language or commentator are different; 3) the event from which the content originates is equal (e.g., a specific football match), but content is provided via different types of media (e.g., one is broadcast video media, while another is cable audio media). Note that these types of “equivalent content” streams are not required to arrive bundled in some access point in any way, nor are they required to come from the same service provider.

Given the various forms of equivalent content, it is apparent that a need exists for an apparatus and method to organize the various contents in equivalency classes which permits the customer to choose that instance of a content which is best suited to his current context and wishes and/or to at least partially automate selection of a preferred content rendering device and an associated preferred content instance or vice versa.

In one aspect of the invention, a method of controlling content rendering to one or more content rendering devices associated with a consumer environment is provided. An initial content reference is received from within the consumer environment. Zero or more equivalent content references associated with the initial content reference are identified. A preferred equivalent content reference associated with the consumer environment is selected from the initial content reference and the equivalent content references. A content instance described by the preferred equivalent content reference is rendered on a first content rendering device.

In another aspect, a consumer environment is provided. The consumer environment includes: a) a means for receiving an initial content reference from within the consumer environment; b) a means for identifying zero or more equivalent content references associated with the initial content reference; c) a means for selecting a preferred equivalent content reference associated with the consumer environment from the initial content reference and the equivalent content references; and d) a means for rendering a content instance described by the preferred equivalent content reference on a first content rendering device.

One advantage of the invention is a content instance having lowest cost can be selected from equivalent contents and rendered to a given content rendering device.

An additional advantage is a content instance having the highest quality can be selected from equivalent contents and rendered to a given content rendering device.

Another additional advantage is, between multiple content rendering devices, the content rendering device most compatible with selected content can be chosen for rendering the content.

Another additional advantage is, between multiple content rendering devices, the higher quality or lower cost combination of equivalent content and content rendering device can be chosen for rendering desired content.

Still another additional advantage is equivalent content can be transferred from one content rendering device to another. During such a transfer the shown stream can change, for example, from a low resolution 160×100 version to a high resolution MPEG version.

Still another additional advantage is support for handover of mobile clients from high bandwidth networks (e.g., WLAN) to low bandwidth networks (e.g., GSM).

Other advantages will become apparent to those of ordinary skill in the art upon reading and understanding the following detailed description.

The drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. Within the drawings, like reference numerals denote like elements and similar reference numerals (e.g., 116, 216) denote similar elements.

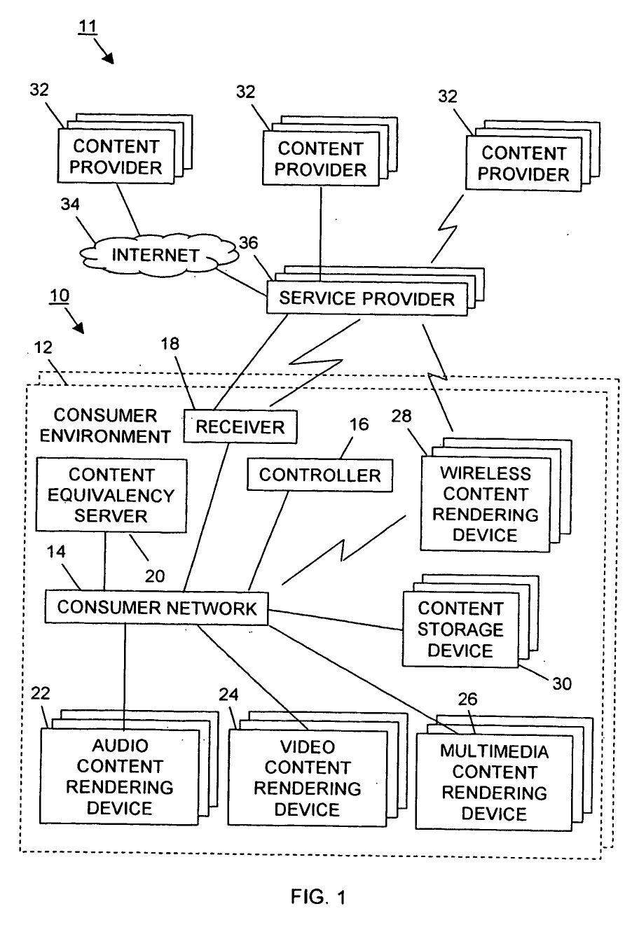

FIG. 1 is a block diagram showing an embodiment of the invention within a framework for distribution of content from content providers to consumers.

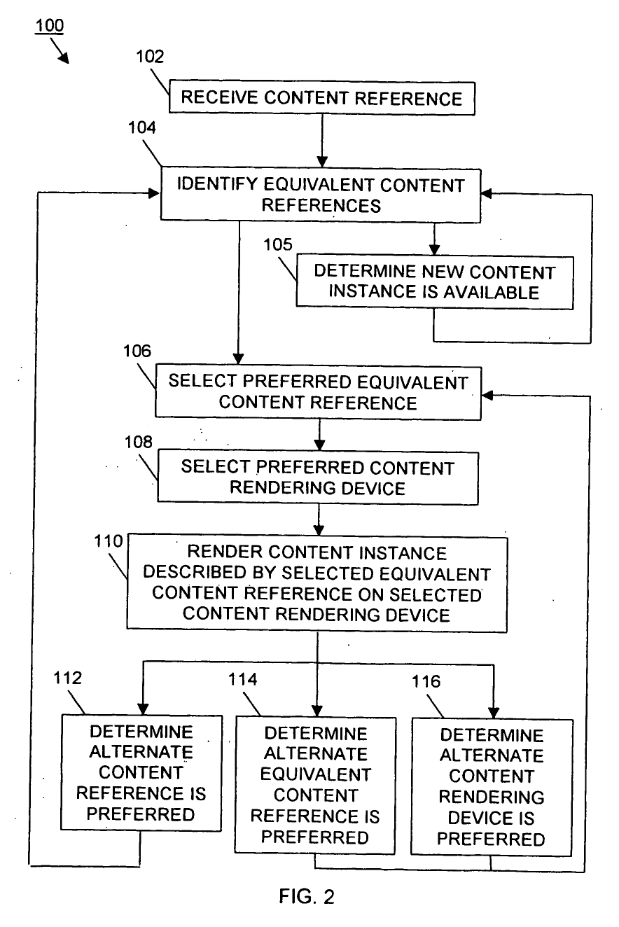

FIG. 2 is a flowchart showing an embodiment of a method for controlling content rendering to one or more rendering devices in a consumer environment.

With reference to FIG. 1, a framework for distribution of content from content providers to consumers includes a consumer portion 10 and an infrastructure portion 11. The consumer portion 10 includes one or more consumer environments 12. Typically, a consumer environment is a home or apartment, a vehicle, an office, and a business. An example of a business environment that may implement this invention is a business that sells audio, video, or multimedia devices (collectively referred to as content rendering devices) to consumers. Another example is a business that makes audio, video, or multimedia content available to consumers via a network of such content rendering devices (e.g., a library or an Internet cafe).

A consumer environment 12 implementing the invention includes a consumer network 14, a controller 16, one or more receivers 18, a content equivalency server 20, and one or more content rendering devices. A content rendering device can present audio, video, or multimedia content to a consumer. The consumer environment 12 may include any combination of one or more audio content rendering devices 22 (e.g., radios, telephones), one or more video content rendering devices 24 (e.g., 3D projectors with limited audio capabilities, personal digital assistants (PDAs) and other types of computers with limited audio capabilities), or one or more multimedia content rendering devices 26 (e.g., television (TVs), 3D projectors, desktop computers and other types of computers with multimedia capabilities, telephones w/video displays).

The consumer environment 12 may also include any combination of wireless audio, video, or multimedia content rendering devices. However, FIG. 1 only shows one type of such wireless devices (i.e., wireless content rendering device 28) in the consumer environment 12 to simplify the drawing. The consumer environment 12 may also include one or more content storage devices 30 (e.g., CD or DVD players, audio or video cassette players, audio or video juke boxes, disk drives).

The infrastructure portion 11 includes one or more content providers 32, the Internet 34, and one or more service providers 36. This encompasses infrastructures for wired and wireless telephone communications, satellite communications, cable TV communications, terrestrial radio and TV broadcasts, and other communication networks capable of distributing content to consumers. The service providers 36 include broadcasters, Internet service providers (ISPs), local and long distance telephone companies, wireless telephone service providers, cable TV service providers, satellite TV service providers, and other types of service providers that offer audio, video, or multimedia content to consumers.

Service providers 36 may provide access to content from multiple content providers 32 and may also provide content (functioning as a service/content provider). Additionally, any content provider 32 may also provide consumers with access to the content (functioning as a content/service provider). The latter is typical for content providers in the radio and TV broadcast area, while the former is common for Internet and cable TV service providers.

A given content provider 32 may provide equivalent content to one or more service providers 36 via the Internet 34, a wired interface, or a wireless interface. The interface between a content provider 32 and a service provider 36 can implement any communication protocol capable of transporting the desired content. The content provider 32 may communicate the same content via multiple types of communication protocols.

Many service providers offer subscription services to consumers. Alternatively, or in addition, service providers may offer such specialty services as pay-for-access, on-demand, and downloads (e.g., movies, music, e-books). There are various business models for the various types of service providers and competition among service providers often leads to various pricing schemes for the same type of service. Service providers 36 can offer consumer access to content via any communication protocol capable of transporting the desired content. The service provider 36 may communicate the same content via multiple types of communication protocols. As shown in FIG. 1, the service provider 36 may provide a consumer environment 12 with access to content via both wired and wireless technology.

The receivers 18 in the consumer environment 12 typically receive content from one or more service providers 36 via wired and wireless interfaces. One receiver 18, for example, may be adapted to receive content via a wired or wireless telephone interface, a satellite TV interface, and a cable TV interface. Alternatively, multiple receivers 18, for example, one for each desired content transport method, can be implemented. Additionally, various combinations of receivers, each receiver having various combinations of content interfaces, are contemplated. Wireless content rendering devices 28 can receive content directly from a service provider 36 via a wireless interface (e.g., RF broadcast, satellite communication, cellular communication, etc.).

Within the consumer environment 12, the controller 16, receivers 18, content equivalency server 20, and rendering devices are in communication via the consumer network 14. The consumer network 14 may use any communications protocol (e.g., IEEE 1394, Ethernet, IEEE 802.11b, Bluetooth, etc.) capable of transporting content compatible with a destination rendering device. Alternatively, the network may be a combination of networks or networked devices utilizing a combination of protocols. Each wireless content rendering device 28 includes a local wireless interface to the consumer network 14 for receiving control information via a communication technology compatible with local wireless communication (e.g., low-level RF, IR). The audio, video, and multimedia content rendering devices 22, 24, 26 are shown with wired interfaces to the consumer network 14 for receiving content and control signals. Any audio, video, or multimedia content rendering device 22, 24, 26 may alternatively include a local wireless interface to the consumer network 14 for receiving content, control signals, or both.

In alternate embodiments, the controller 16, receiver 18, and content equivalency server 20 may be combined in one device or in various combinations of devices. In further alternate embodiments, any of the controller 16, receiver 18, or content equivalency server 20 components may be combined in one or more content rendering devices.

The controller 16 typically includes a user interface comprising a display device (e.g., display monitor) and an input device (e.g., keyboard, mouse or other type of pointing device, keypad or other type of switches/controls). Additionally, or in the alternative, any device (e.g., rendering device, CE device) in communication with the consumer network 14 may include a similar user interface.

The receiver 18 typically receives an electronic program guide (EPG) or the like from each service provider 36 with which an owner of the consumer network 14 has subscribed or from a third party provider. This program content information and on-demand content information from the service providers 36 is stored in the content equivalency server 20. Additionally, the content equivalency server 20 maintains local content information for items available from any content storage devices 30. The local content information includes downloaded content and content otherwise purchased (e.g., CD-ROMs, DVD-ROMs, cassette tapes) by the owner of the consumer network 14.

In one embodiment, the receiver 18 also receives equivalent content information from a particular content provider 32 via a service provider 36. This particular content provider 32 offers equivalent content information as a special service. Thus, content equivalencies are provided by an external party or service to the consumer environment 12. For example, in this embodiment equivalent content information may be provided via a search engine on the Internet. The search engine may accept a search request identifying a particular content and return equivalent content for program channels, on-demand channels, download libraries, and content available through retail sales outlets. Equivalent content that is simultaneously available is often specially noted. The retrieved equivalent content information is stored in the equivalent content server 20. The external content equivalency service can be based on an Internet server. Similarly, the Internet server may include a distributed hierarchy, for example, similar to current domain name server (DNS) setups that ask another server if an answer is not found locally.

An example of equivalent content for a particular football match includes live program channel content, delayed program channel content, and download content. Of course, the delayed program channel content may be equal to a live program channel content if it is merely a delayed (i.e., rerun) version of the live program. The equivalent program channel content includes TV broadcasts, radio broadcasts, cable TV transmissions, and satellite TV transmissions of the match. Often, original programming is generated independently in the home city of each team. The download content includes recorded video streams, and recorded audio streams.

The controller 16 may include processes that monitor the user interface to determine if a consumer has requested content. A consumer can request content by selecting a particular content reference from a list of alternatives on the user interface or by setting a particular rendering device to a particular communication channel. The list of alternative content references is constructed by the controller 16 based on the program, on-demand, and local inventory content information stored in the content equivalency server 20.

When a content request is received, in the embodiment being described, the controller 16 submits a search request to the content provider 32 offering equivalent content information. The controller 16 compares the equivalent content information to compatible rendering devices in the consumer network and local inventory content available to the consumer via a content storage device 30. The controller 16 displays the equivalent content information to the consumer on the user interface. Typically, equivalent content that is already in local inventory is highlighted. Similarly, rendering devices that are currently in use may be “downlighted” (e.g., ghosted, shaded, hidden). Additionally, the controller 16 can display the consumer(s) currently receiving content at the rendering device that is in use. This is accomplished in embodiments of the invention that incorporate consumer identification by, for example, a login procedure at the rendering device or, alternatively, a consumer monitoring device that recognizes consumers within a cognitive range of the rendering device according to a mapped or detected location for the rendering device. Conflicts between consumers at a given rendering device can be resolved based on a priority scheme either manually or automatically by the controller 16. If a consumer does not have priority higher the consumer(s) currently using the rendering device, the controller 16 may mask or gray out equivalent content associated with that rendering device on the user interface.

At the user interface, the consumer selects the device on which he or she desires the content to be rendered and proceed to the vicinity of the selected device. The controller 16 sets the selected rendering device to the appropriate channel so that the device is ready when the consumer is within cognitive range of the device. If the selected content is from a storage device 30, the controller 16 sets up the storage device 30 and either provide instructions to the consumer regarding the location and loading of the desired content or automatically load the desired content so that it is ready when the consumer is within cognitive range of the selected rendering device.

In another embodiment, the content equivalency server 20 provides equivalent content information much like the search engine technique described above. The content equivalency server 20 may analyze the EPG and like information provided by the various service providers 36 to identify content equivalencies. Where content descriptions or metadata are embedded within content, the content equivalency server 20 dynamically captures descriptions and metadata and analyze stored descriptions and metadata to identify content equivalencies. Additionally, the content equivalency server 20 retrieves comparable information about content from any content provider offering such information via an associated service provider. Furthermore, the content equivalency server 20 dynamically samples content to identify content equivalencies. In the embodiment being described, the consumer interfaces with the controller 16 in the same manner as described above.

In still another embodiment, content providers 32 and service providers 36 annotate content with links to equivalent content. The content equivalency server 20 receives and stores the links in the EPG and like information provided by the various service providers 36. When a content request is received, in the embodiment being described, the controller 16 retrieves the equivalent content links from the content equivalency server 20. The controller 16 compares the equivalent content links to compatible rendering devices in the consumer network and local inventory content available to the consumer via a content storage device 30. The controller 16 displays the equivalent content links to the consumer on the user interface. Otherwise, in the embodiment being described, the consumer interfaces with the controller 16 in the same manner as described above.

In yet another embodiment, the controller 16 suggests which equivalent content instance provides the highest quality rendering to the consumer given the rendering devices available in the consumer network 14. Alternatively, the controller 16 automatically selects the equivalent content instance and rendering device that results in the highest quality rendering.

In still yet another embodiment, the controller 16 suggests which equivalent content instance provides the lowest cost to the consumer given the rendering devices available in the consumer network 14. There are at least two costs (e.g., monetary cost and computing/network performance cost) associated with rendering content. The monetary cost, for example, is a cost associated with the bandwidth/time used on the Internet connection as well as the cost for the content itself. The computing/network performance cost, for example, is a cost associated with the use of available bandwidth in the home network when transmitting the content as well as the computing power expended on rendering or encoding devices. In this embodiment, the consumer may select a preferred type of rendering device from the audio, video, or multimedia types available. Alternatively, the controller 16 automatically selects the equivalent content instance and rendering device that results in the lowest cost rendering.

In another embodiment, the controller 16 may select equivalent content references based on a user profile/preference. The user profile/preference, for example, may restrict the kinds of equivalent content that are carried forward for ultimate selection of a content instance. As described above, different types of content equivalencies include: 1) content that is exactly the same with different encoding characteristics, 2) content that is the same, but, for example, the language or commentator are different, and 3) the event from which the content originates is equal, but content is provided via different types of media. Any distinguishable type of equivalent content can be restricted based on the user profile/preference. The controller 16 based on past selections by the user may construct the user profile/preference. Alternatively, the user may enter the user profile/preference via, for example, the user interface.

In yet another embodiment, the controller 16 uses the user interface to suggest or automatically transfer content being rendering on a particular rendering device to equivalent content on a different rendering device. This is implemented, for instance, when a consumer enters the consumer environment 14 listening to a football match on a portable radio and the controller 16 recognizes that a higher quality or lower cost equivalent content instance is available on another rendering device within the cognitive range of the consumer. In the embodiment being described, consumer identification techniques described above and similar techniques for identifying rendering devices can be implemented. For relatively stationary rendering devices, mapping techniques described above can be implemented.

With reference to FIG. 2, an embodiment of a method 100 for controlling content rendering to one or more rendering devices in a consumer environment begins at a step 102 in which the consumer environment receives a content reference. The content reference is generated by a request for content from a consumer. The consumer's request is typically conveyed to the consumer network by selecting a content reference from a list of content references previously compiled by the consumer network and presented to the consumer via a user interface. Alternatively, the consumer may request content by selecting a specific content instance on a particular rendering device (e.g., tuning the rendering device to a certain channel or frequency) or by selecting a specific content reference on a particular rendering device (e.g., selecting a content reference from a user interface associated with the rendering device).

At a step 104 the consumer environment identifies equivalent content references associated with the received content reference. Typically, content equivalencies are previously determined by: 1) the consumer environment or 2) a third party content provider offering content equivalencies to consumers as a special service. Determination of content equivalencies is described above in more detail in reference to FIG. 1.

At a step 106, the consumer network selects a preferred equivalent content reference that is accessible to the consumer network from the equivalent content references. The preferred equivalent content reference is selected automatically, selected semi-automatically (i.e., suggested by the consumer network and confirmed by a consumer via a user interface), or selected by the consumer via the user interface. Selection of the preferred equivalent content reference is typically based on multiple factors, including the quality or resolution of the content and the cost to the consumer.

At a step 108, the consumer network selects a preferred content rendering device based on the selected content reference. This selection can be automatic, semi-automatic, or performed by the consumer. Selection is typically based on multiple factors. Typically, the highest quality or highest resolution rending device compatible with the selected equivalent content reference is chosen. If the selected rendering device is in use by another consumer, the consumer network resolves the device conflict. Resolution of device conflicts is described above in reference to FIG. 1.

At a step 110, the consumer network controls the selected content rendering device so that it renders the content instance described by the selected equivalent content reference. The selected content rendering device may be wired or wireless with respect to the consumer network, as described above in reference to FIG. 1. Moreover, the selected content rendering device can be wired or wireless with respect to a service provider, also as described above in reference to FIG. 1.

In extensions to the embodiment of the method being described, once the initial content reference received has been serviced, the consumer network is able to: 1) determine that an alternate content reference is preferred (step 112), 2) determine that an alternate equivalent content reference is preferred (step 114), or 3) determine that an alternate content rendering device is preferred.

If the consumer network determines that alternate content reference is preferred at the step 112, the method returns to the step 104. The consumer network may determine this by various techniques, including 1) a request for alternate content reference by the consumer via the user interface or 2) from the consumer tuning the selected rendering device to a different channel or frequency to receive a content instance that is not equivalent to the previous content instance rendered in step 110.

If the consumer network determines that an alternate equivalent content reference is preferred at the step 114, the method returns to the step 106. The consumer network is able to determine this by various techniques, including 1) a request for an alternate equivalent content reference by the consumer via the user interface, 2) by recognizing that the consumer has tuned the selected rendering device to a different channel or frequency to receive a content instance that is equivalent to the previous content instance rendered in step 110, or 3) by recognizing that the consumer has selected an alternate equivalent content reference on an alternate rendering device.

If the consumer network determines that an alternate content rendering device is preferred at the step 116, the method also returns to the step 106 because the alternate content rendering device may be more compatible with an alternate equivalent content reference. The consumer network determines this by various techniques, including 1) a request for an alternate content rendering device by the consumer via the user interface, 2) if the alternate content rendering device is mobile, moving the alternate device within a proximity of the previously selected device (indicating that the consumer desires the content being rendered on the selected device to be transferred to the alternate device), 3) conversely, if the selected rendering device is mobile, moving the previously selected device within a proximity of the alternate device (likewise, indicating that the consumer desires the content to be transferred), or 4) by recognizing that the consumer has selected the same content instance previously rendered in step 110 on an alternate rendering device by tuning the alternate rendering device to a particular channel or frequency.

In another extension to the embodiment of the method being described, after the equivalent content references are identified in step 104, the consumer network determines that one or more new content instances are available (step 105). The equivalent content references in the step 104 are updated based on the new content instance(s). Accordingly, the next time the steps 104 and 105 are performed, the updated equivalent content references are provided. The “refresh” cycle provided by this extension could be based on polling or it could be event driven.

References to content (e.g., URNS) and instances of content (e.g., files/streams at URLs) are decoupled in the method described above and shown in FIG. 2. In one embodiment of the method, URN-strings are used (e.g., urn:wwice:content@homelab:harry-potter-movie-original) to uniquely and persistently identify content that can subsequently be resolved into sources that can deliver the content (e.g., a tuner or a hard disk). An equivalent content could then be the director's-cut version of the original movie (e.g., urn:wwice:content@homelab:harry-potter-move-directors-cut), which can be resolved into a set of sources (not necessarily the same set as those providing the original movie).

In one embodiment of the invention, the consumer network 12 (FIG. 1) includes middleware within the controller 16, receiver 18, and/or content equivalency server 20. One or more steps of the method for controlling content rendering described above and shown in FIG. 2 may be implemented in the middleware. As is known in the art, the middleware enables the shared functionality across networked applications and services within the consumer network 12.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. A method of controlling content rendering to one or more content rendering devices associated with a consumer environment comprising:
a) receiving an initial content reference from within the consumer environment;
b) identifying zero or more equivalent content references associated with the initial content reference;
c) selecting a preferred equivalent content reference associated with the consumer environment from the initial content reference and the equivalent content references;
d) rendering a content instance described by the preferred equivalent content reference on a first content rendering device.

2. The method as set forth in claim 1 wherein the first content rendering device is selected from the group consisting of a radio, an audio telephone, a personal digital assistant, a personal computer, a television, a video telephone, and similar devices.

3. The method as set forth in claim 1 wherein the initial content reference is received from a user interface associated with the consumer environment.

4. The method as set forth in claim 1 wherein the initial content reference is received from a first content rendering device associated with the consumer environment.

5. The method as set forth in claim 1 wherein the equivalent content instances include at least one of the group consisting of audio content instances, video content instances, and multimedia content instances.

6. The method as set forth in claim 1, prior to step a), further including: compiling one or more equivalent content references for content instances available to the consumer environment.

7. The method as set forth in claim 6 wherein the equivalent content references are compiled by a content equivalency server associated with the consumer environment.

8. The method as set forth in claim 7 wherein the equivalent content references are at least partially generated from one or more of:
links associated with one or more available content instances to one or more equivalent content instances;
metadata associated with one or more available content instances;
the content equivalency server; and
an equivalent content information provider and communicated to the content equivalency server.

9. The method as set forth in claim 1 wherein the preferred equivalent content reference is selected automatically.

10. The method as set forth in claim 9 wherein the automatic selection is at least partially based on at least one of:
a cost to render a content instance associated with the preferred equivalent content reference;
quality of the content instance associated with the preferred equivalent content reference; and
a user profile/preference restricting the types of equivalent content that are identified.

11. The method as set forth in claim 1 wherein the preferred equivalent content reference is selected by a user from a user interface associated with the consumer environment.

12. The method as set forth in claim 11 wherein a suggested preferred equivalent content reference is automatically provided to the user via the user interface prior to selection of the preferred equivalent content reference by the user.

13. The method as set forth in claim 1, further including:
determining that an alternate content reference is preferred and returning to step b).

14. The method as set forth in claim 1, further including: determining that an alternate equivalent content reference is preferred and returning to step c).

15. The method as set forth in claim 1, further including between steps b) and d):
selecting a preferred content rendering device associated with the consumer environment, the preferred content rendering device being compatible with a content instance associated with the preferred equivalent content reference, the content rendered in step d) being rendered on the preferred content rendering device.

16. The method as set forth in claim 15 wherein the preferred content rendering device is selected automatically.

17. The method as set forth in claim 15 wherein the preferred content rendering device is selected by a user from a user interface associated with the consumer environment.

18. The method as set forth in claim 15, further including: determining that an alternate content rendering device is preferred and returning to step c).

19. A consumer environment, comprising:
a) a means for receiving an initial content reference from within the consumer environment;
b) a means for identifying zero or more equivalent content references associated with the initial content reference;
c) a means for selecting a preferred equivalent content reference associated with the consumer environment from the initial content reference and the equivalent content references; and
d) a means for rendering a content instance described by the preferred equivalent content reference on a first content rendering device.

20. The consumer environment as set forth in claim 19, further including:
e) a means for selecting a preferred content rendering device associated with the consumer environment, which preferred content rendering device is compatible with the content instance associated with the preferred equivalent content reference, the step (d) means renders the content instance on the preferred content rendering device.

21. A consumer environment, comprising:
a consumer network;
a receiver in communication with the consumer network and adapted to receive a plurality of content instances from service providers;
a content equivalency server in communication with the consumer network to store content equivalency information associated with the plurality of content instances;
a first content rendering device in communication with the consumer network, for selectably rendering a particular content instance; and
a controller in communication with the consumer network to receive a content reference and, based on the content reference, 1) to select a preferred content reference from a plurality of content references describing the plurality of content instances and 2) to render a content instance described by the preferred content reference to the first content rendering device.

22. The consumer environment as set forth in claim 21, further including:
one or more additional content rendering devices, each in communication with the consumer network, for selectably rendering a content instance, wherein the controller is to select a preferred content rendering device from the first and additional content rendering devices based on the initial content reference, wherein the content instance rendered by the controller is rendered to the preferred content rendering device.
